(19) United States
(12) Patent Application Publication
(10) Pub. No.: US 2019/0014588 A1
(43) Pub. Date: Jan. 10, 2019

(54) USER TERMINAL, RADIO BASE STATION, AND RADIO COMMUNICATION METHOD

(71) Applicant: NTT DOCOMO, INC., Tokyo (JP)

(72) Inventors: Yoshihisa Kishiyama, Tokyo (JP); Kiichi Tateishi, Tokyo (JP)

(73) Assignee: NTT DOCOMO, INC., Tokyo (JP)

(21) Appl. No.: 16/080,399

(22) PCT Filed: Feb. 27, 2017
(86) PCT No.: PCT/JP2017/007504

§ 371 Date: Aug. 28, 2018

(30) Foreign Application Priority Data
Feb. 29, 2016 (JP) 2016-038173

(51) Int. Cl. H04W 72/12; H04L 5/14

(52) U.S. Cl. CPC H04W 72/121; H04L 5/1469; H04L 5/0007; H04W 72/1268; H04W 72/1231; H04W 72/1289

(57) ABSTRACT

To appropriately prevent interference, even when UL or DL is controlled in a dynamic manner, a user terminal for performing communication using a transmission time interval (TTI) having a certain TTI length includes a measurement unit for performing measurement using a measurement resource dynamically assigned by a radio base station, and a transmission unit for transmitting information related to a measurement result. The measurement unit performs measurement of a signal transmitted from another user terminal using the measurement resource.

### TECHNICAL FIELD

The present invention relates to a user terminal, a radio base station, and a radio communication method in next-generation mobile communication systems.

### BACKGROUND ART

In UMTS (Universal Mobile Telecommunications System) networks, LTE (Long Term Evolution) has been specified for the purpose of providing increased data rates, reduced delay, and the like (non-patent document 1). To achieve further broadbandization and increased speed beyond LTE, successor systems to LTE (such as LTE-A (LTE-Advanced), FRA (Future Radio Access), 5G (5th generation mobile communication system), and New-RAT (Radio Access Technology)) are studied.

Existing LTE systems use controls based on TDD (Time Division Duplex) and FDD (Frequency Division Duplex). For example, in TDD, whether each subframe is used for uplink (UL) or downlink (DL) is strictly determined based on UL/DL configurations.

To be more specific, in radio communication systems using TDD, UL/DL configurations each of which represents the configuration (ratio) between uplink subframes and downlink subframes in a radio frame are specified. FIG. 1 is a table listing UL/DL configurations in the existing LTE systems. As depicted in FIG. 1, seven UL/DL configurations numbered 0 to 6 are specified in the existing LTE systems.

### CITATION LIST

Non-patent document 1: 3GPP TS 36.300 “Evolved Universal Terrestrial Radio Access (E-UTRA) and Evolved Universal Terrestrial Radio Access Network (E-UTRAN); Overall description; Stage 2”

In general, traffic ratios are not always constant, but vary temporally or locally. Thus, in radio communication systems using TDD, it is necessary to dynamically change a UL/DL resource configuration in a certain cell (transmission point or radio base station) in accordance with the traffic variation, in order to provide efficient use of radio resources.

Therefore, TDD in LTE Release 12 or later studies a scheme (referred to as dynamic TDD or eIMTA (enhanced Interference Mitigation and Traffic Adaptation)) in which the transmission ratio between DL subframes and UL subframes is changed in a dynamic or semi-static manner in a time domain in each transmission and reception point (or each radio base station or each cell).

In future radio communication systems using dynamic TDD, it is studied that a transmission point (e.g., radio base station) performs an independent UL/DL control on a user terminal-by-user terminal basis. However, application of dynamic TDD may cause a situation in which adjacent transmission points have different transmission directions (communication directions). This may cause significant interference between UL and DL, thus reducing communication quality.

### SUMMARY OF INVENTION

Considering the above, one of objects of the present invention is to provide a user terminal, a radio base station, and a radio communication method that can appropriately prevent interference, even when UL or DL is controlled in a dynamic manner.

A user terminal according an aspect of the present invention performs communication using a transmission time interval (TTI) having a certain TTI length. The user terminal includes a measurement unit for performing measurement using a measurement resource dynamically assigned by a radio base station, and a transmission unit for transmitting information related to a measurement result. The measurement unit performs measurement of a signal transmitted from another user terminal using the measurement resource.

According to the present invention, even when UL or DL is controlled in a dynamic manner, it is possible to appropriately prevent interference.

### BRIEF DESCRIPTION OF DRAWINGS

FIG. 1 is a table listing UL/DL configurations in existing LTE;

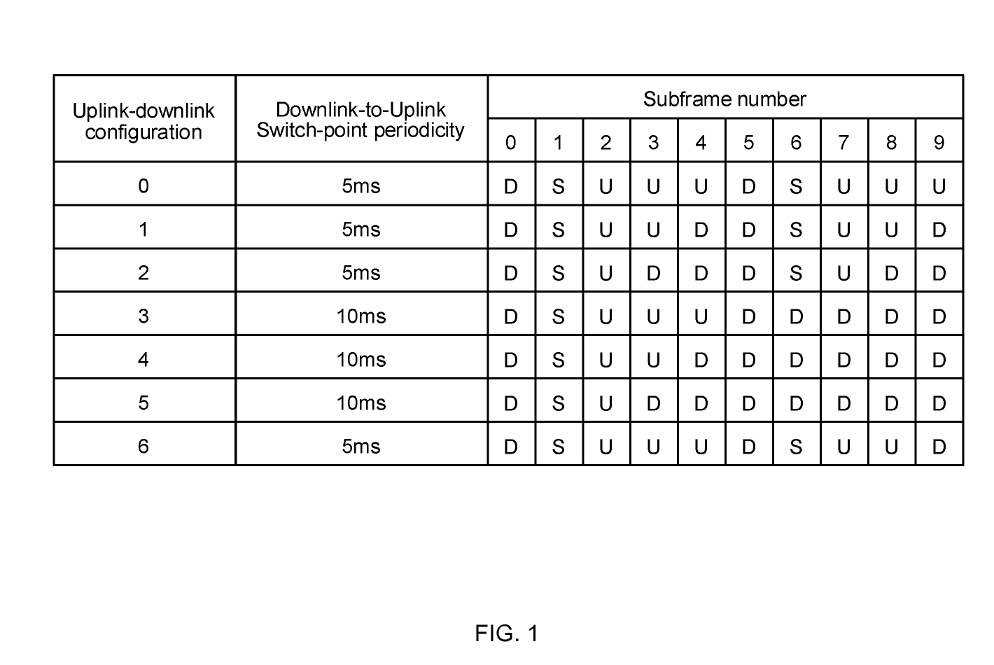

FIG. 2 is a drawing depicting an example of a network configuration for realizing dynamic TDD;

FIG. 3 is a drawing depicting an example of UL/DL interference that occurs when using dynamic TDD;

FIG. 4 is a drawing depicting an example of interference information feedback;

FIGS. 5A and 5B are drawings depicting an example of an interference measurement method according to an embodiment;

FIGS. 6A and 6B are drawings depicting an example of TTI structure including RS resources and an MR;

FIGS. 7A and 7B are drawings depicting another example of the TTI structure including the RS resources and the MR;

FIGS. 8A and 8B are drawings depicting another example of the TTI structure including the RS resources and the MR;

FIG. 9 is a drawing depicting an example of the schematic configuration of a radio communication system according to an embodiment of the present invention;

FIG. 10 is a drawing depicting an example of the entire configuration of a radio base station according to an embodiment of the present invention;

FIG. 11 is a drawing depicting an example of the functional configuration of a radio base station according to an embodiment of the present invention;

FIG. 12 is a drawing depicting an example of the entire configuration of a user terminal according to an embodiment of the present invention;

FIG. 13 is a drawing depicting an example of the functional configuration of a user terminal according to an embodiment of the present invention; and

FIG. 14 is a drawing depicting an example of the hardware configuration of each of a radio base station and a user terminal according to an embodiment of the present invention.

### DESCRIPTION OF EMBODIMENTS

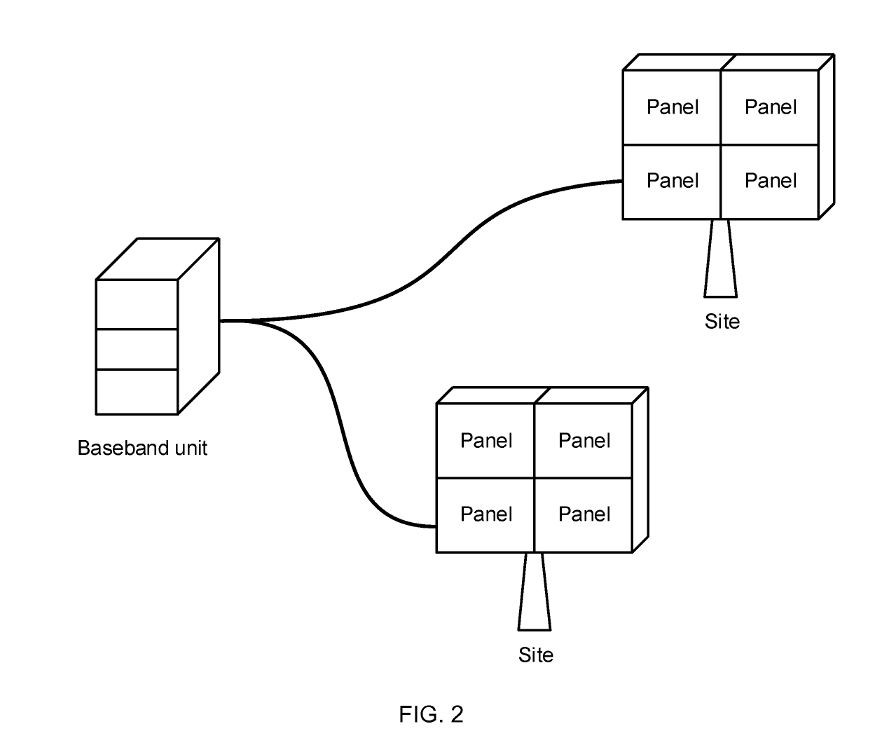

The operation of dynamic TDD will be first described. FIG. 2 is a drawing depicting an example of a network configuration for realizing dynamic TDD. In FIG. 2, a baseband unit (BBU) is connected to sites constituted of panels with wires (e.g., optical fibers).

The BBU applies baseband signal processing (e.g., modulation, demodulation, precoding, and the like) to signals to be transmitted and/or received. The baseband signals are inputted to and outputted from the sites connected to the BBU.

The site performs radio communication control such as conversion of baseband signals into radio signals and transmission of the radio signals, and conversion of received radio signals into baseband signals. The site may be referred to as an RRH (remote radio head), an RRE (remote radio equipment), and the like.

The site is provided with one or more panels (panel antennas). Each panel may be constituted of a plurality of antenna elements. For example, ultra-multi-element antennas may be used to realize massive MIMO (Multiple Input Multiple Output). Controlling the amplitudes and/or phases of signals transmitted from or received by each element of the ultra-multi-element antennas facilitates forming beams (antenna directivity). This processing is also referred to as beamforming (BF) and serves to reduce radio propagation loss.

In the network configuration of dynamic TDD, at least part of the above-described BBU, sites, and panels are integrated so as to provide the functions of an eNB (evolved Node B), and establish communication with user equipment (UE).

FIG. 2 is merely an example, and the network configuration of dynamic TDD is not limited thereto. For example, the BBU may be wirelessly connected to the sites, and the number of each device is arbitrary. The site may include other antennas instead of or in addition to the panels, and use the antennas for communication in dynamic TDD.

As dynamic TDD realized in the configuration of FIG. 2, there are baseband centric (BB centric) dynamic TDD, site centric dynamic TDD, panel centric dynamic TDD, and the like.

In BB centric dynamic TDD, the communication directions (UL/DL) of a plurality of sites included in (connected to) the same BB are unified in certain time units (e.g., Transmission Time Interval (TTI)). In this case, the communication directions of all panels included in the sites are unified into the same direction. Thus, for example, assuming a situation in which there is only one BBU, no UL/DL interference occurs.

The UL/DL interference refers to interference occurring between a plurality of devices having different communication directions. The UL/DL interference includes uplink-to-downlink (U2D) interference wherein an uplink signal transmission of a certain device applies to a downlink signal transmission of another device, downlink-to-uplink (D2U) interference wherein a downlink signal transmission of a certain device applies to an uplink signal transmission of another device, and the like. The UL/DL interference may be referred to as interference between UL and DL, inter-link interference, inter-cell interference, and the like.

In site centric dynamic TDD, a plurality of sites included in the same BB are allowed to independently perform UL/DL communication. Although this scheme may bring about UL/DL interference of a problematic level between the sites, site centric dynamic TDD allows an increased adaptation gain against traffic than BB centric dynamic TDD.

In panel centric dynamic TDD, a plurality of panels included in the same site are allowed to independently perform UL/DL communication. Although this scheme may bring about UL/DL interference of a problematic level between the panels, panel centric dynamic TDD allows an increased adaptation gain against traffic than site centric dynamic TDD.

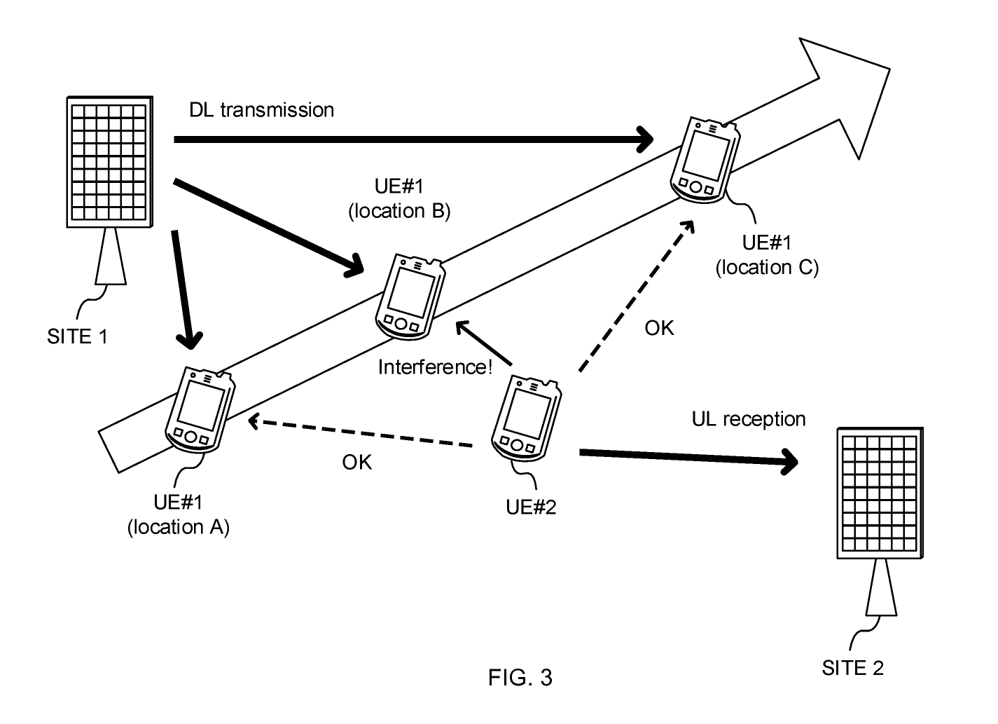

Although radio communication systems using dynamic TDD study an eNB performing an independent UL/DL control of each UE, communication quality deteriorates unless a strict interference control is applied. This problem will be specifically described with reference to FIG. 3.

FIG. 3 is a drawing depicting an example of UL/DL interference that occurs when using dynamic TDD. This example performs a control based on site centric dynamic TDD. FIG. 3 depicts a situation in which in a certain time period, a site 1 performs DL transmission to a UE#1, while a site 2 performs UL reception from a UE#2.

UE#1 is moving from a location A through a location B to a location C in this time period, while receiving a DL signal from site 1. UE#2 remains in the vicinity of location B, and is relatively distant from location A and location C.

When UE#1 is situated in the vicinity of location A or location C, UL/DL interference hardly occurs between the DL transmission of site 1 and the UL reception of site 2 because the distance between UE#1 and UE#2 is great. However, when UE#1 is situated in the vicinity of location B, UL/DL interference occurs, thus causing, for example, a deterioration in the quality of the DL signal received by UE#1.

The interference depicted in FIG. 3 may occur when a plurality of radio communication systems using BB centric dynamic TDD coexist, as well as in one radio communication system using site centric or panel centric dynamic TDD. The inventors have focused on the fact that to realize appropriate dynamic TDD, it is important to quickly perform coordinated scheduling between eNBs by following the movement of a UE.

Therefore, the inventors have discovered that dynamic measurement of interference of a user terminal next to a certain user terminal and feedback of the interference serve to control interference coordination in a dynamic manner in a radio base station.

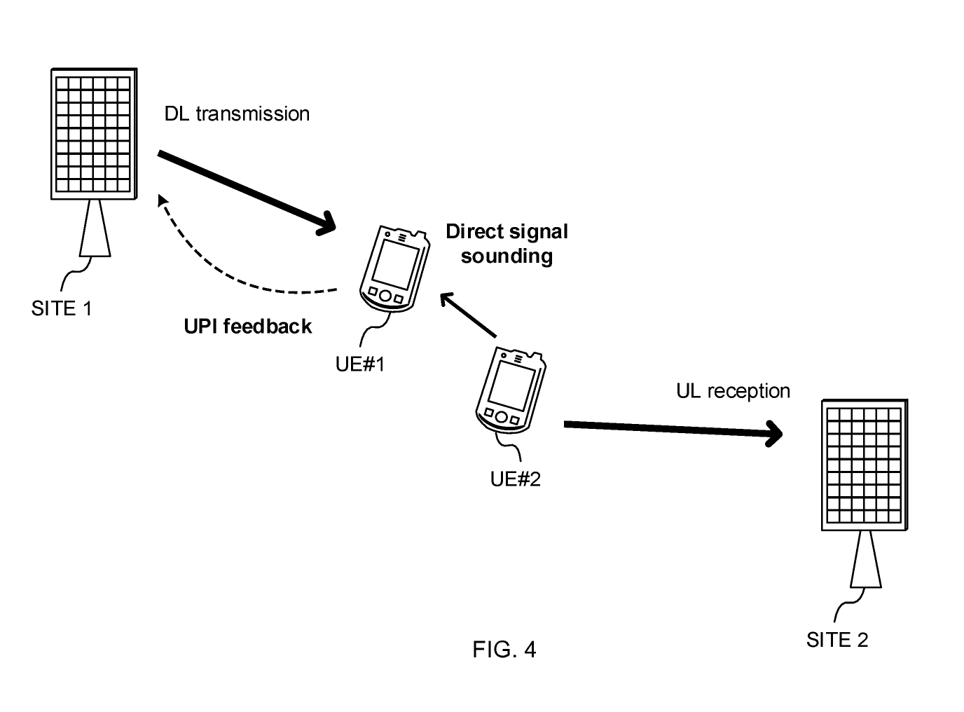

The user terminal dynamically feeds back information (UPI: user proximity indicator) related to interference of the other user terminal to the radio base station with the use of a certain measurement resource (see FIG. 4). The user terminal feeds back the level of a reception signal and information indicating the reception signal (at least one of user identification, a reference signal series, a received TTI, and the like) to the radio base station, as the information (UPI) related to the interference of the other user terminal (e.g., next user terminal). As the certain measurement resource, a resource on which another user terminal transmits a reference signal (e.g., SRS or eSRS) and a zero-power CSI-RS are available.

The user terminal can feed back the UPI in a dynamic manner concurrently with transmission of at least one of a delivery confirmation signal (e.g., NACK), a BSR (buffer status report), and a CSI report. Thus, even when transmission points concurrently perform UL transmission and DL transmission, it is possible to reduce interference between the user terminals in a dynamic manner.

In one aspect of an embodiment, a user terminal measures a signal transmitted from another user terminal using a measurement resource that is dynamically assigned by a radio base station, and feeds back a measurement result to the radio base station. The other user terminal transmits a reference signal using a dynamically assigned reference signal transmission resource. The measurement resource and the reference signal transmission resource that are assigned to the different user terminals (e.g., user terminals that are connected to different transmission points and next to each other) correspond to each other.

The embodiment will be described below in detail with reference to the drawings. Each of the radio communication methods according to the embodiment may be used alone or in combination.

In the following embodiment, a subframe (TTI) may be a subframe (1 ms) in existing LTE, an interval shorter (e.g., any of 1 to 13 symbols) than 1 ms, or an interval longer than 1 ms.

In the following description, a reference signal is used in measurement of interference from another user terminal, but the type of the reference signal is not specifically limited. As the reference signal, any of SRS, eSRS, CSI-RS, and CRS or a combination thereof may be used, or another signal may be used. In the following description, a dynamic control includes a control using TTIs a certain time period (a plurality of TTI lengths) apart, as well as a control in the same TTI. As the certain time period, for example, when a short TTI having a TTI length shorter than 1 ms is used, the certain time period may be set at 1 ms.

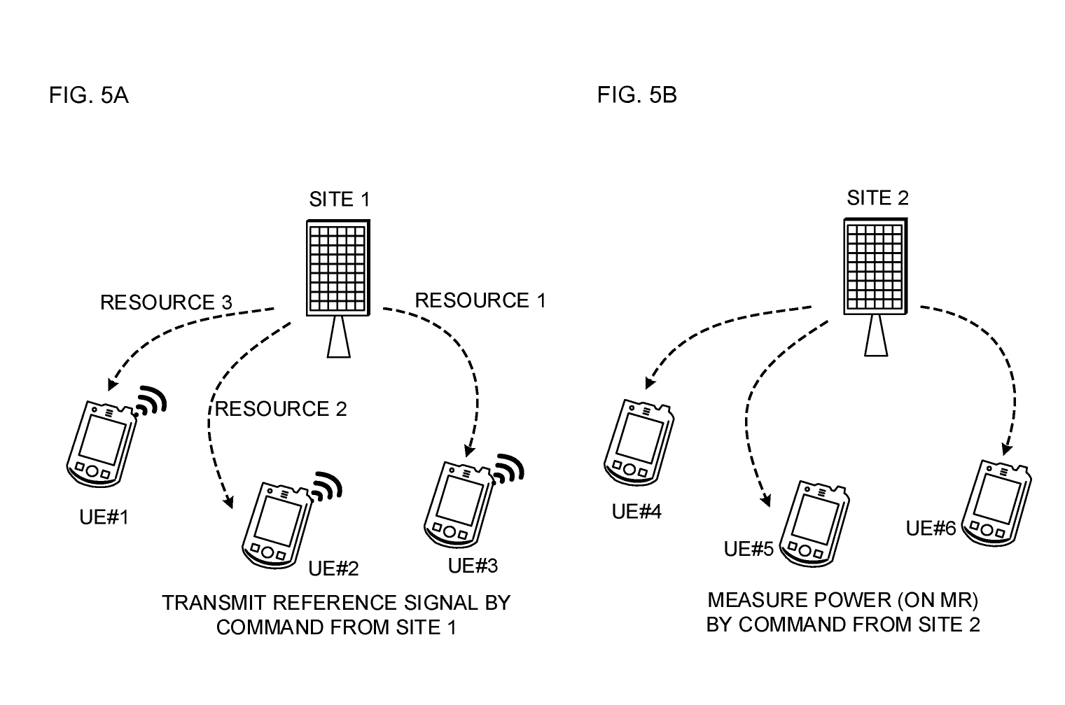

FIGS. 5A and 5B depict a case where different transmission points (radio base stations or sites) command user terminals to transmit reference signals and to perform measurement (e.g., power measurement), respectively. To be more specific, a first radio base station (site 1) dynamically designates a resource (reference signal transmission resource) to transmit a reference signal for each of user terminals (UE#1 to #3). A second radio base station (site 2) dynamically designates a resource (measurement resource) to perform power measurement for user terminals or a user group (UE#4 to #6). The first radio base station and the second radio base station may be connected through a backhaul link.

The reference signal transmission resource indicates any of time, a frequency, and a code, or a combination thereof. The first radio base station may transmit information about an identifier of the user terminal (or a reference signal line) to the user terminal, in addition to the transmission command of the reference signal. The reference signal transmission resource is different from UE to UE.

The second radio base station may designate a plurality of measurement resources (e.g., a plurality of symbols) for the user terminals (UE#4 to #6). The measurement resources may be provided in common with the UE#4 to #6. The reference signal transmission resources designated for the UE#1 to #3, respectively, and the measurement resources designated for the UE#4 to #6 correspond to each other.

The UE#1 to #3 transmit reference signals using the reference signal transmission resources, which are dynamically designated by the first radio base station. The UE#4 to #6 measure the reception power of the reference signals transmitted from the UE#1 to #3, respectively, using the measurement resources, which are dynamically designated by the second radio base station, and feed back a measurement result (e.g., UPI) to the second radio base station. The second radio base station that has received the measurement result from the UE#4 to #6 informs the first radio base station of the measurement result.

Thus, the first radio base station and the second radio base station can control interference coordination in a dynamic manner by grasping interference conditions of the UE#4 to #6 affected by the other UEs, i.e., UE#1 to #3. As a result, even when the transmission points concurrently perform UL transmission and DL transmission, it is possible to reduce interference between the user terminals in a dynamic manner.

The following describes an example of a case in which resources for reference signal transmission and resources for measurement are assigned to user terminals in a dynamic manner. The resource for reference signal transmission may be referred to as an RS resource or a signal transmission resource. The resource for measurement may be referred to as a measurement resource, an MR, or an interference estimation resource.

<First Aspect>

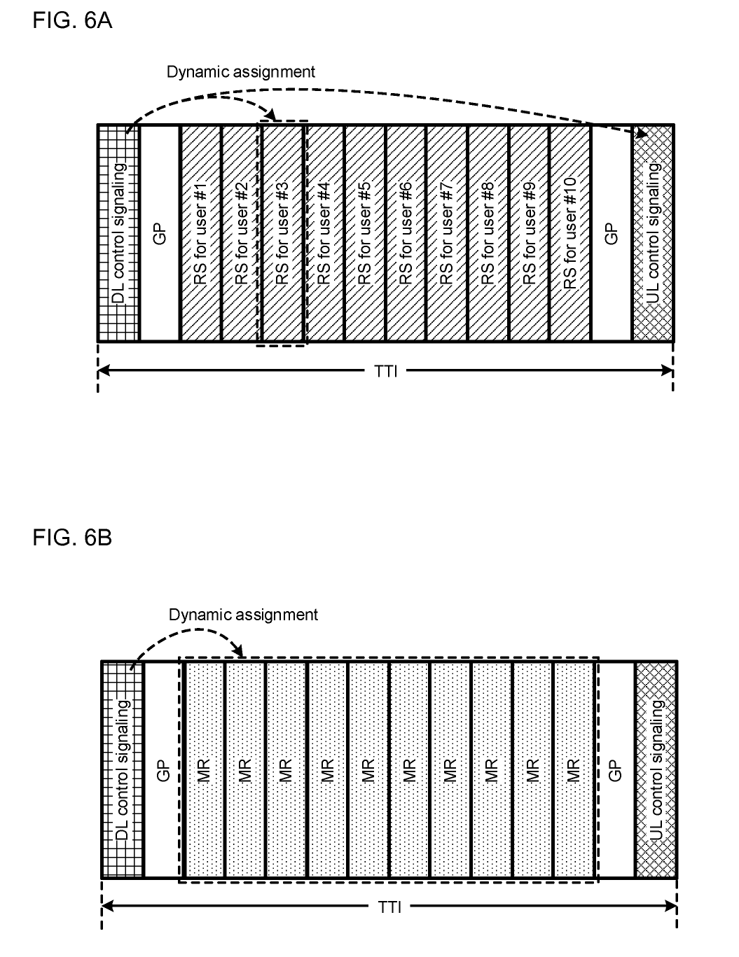

FIGS. 6A and 6B depict an example of a method for assigning reference signal transmission resources (RS resources) and a measurement resource (MR) in a TTI. FIG. 6A depicts a case where a first radio base station (first site) assigns RS resources to user terminals (UE#1 to #10). FIG. 6B depicts a case where a second radio base station (second site) assigns an MR to other user terminals.

In FIGS. 6A and 6B, the RS resources assigned to the UE#1 to #10 and the MR assigned to the other UEs correspond to each other. The RS resources are assigned in a time-shared manner in FIG. 6A, but not limited thereto, may be assigned in a frequency division manner, or in a combination of time-shared and frequency division manner.

In FIGS. 6A and 6B, one TTI is constituted of fourteen symbols (e.g., fourteen OFDM symbols), but is not limited thereto. Each TTI is preferably constituted of symbols the number of which is sufficient for obtaining an adequate temporal particle size (flexibility to symbol change), and a downlink control signal is preferably assigned to at least one or more symbols.

The TTI depicted in FIG. 6A includes a downlink control signal section to which a downlink control signal is assigned, a reference signal transmission section in which reference signals are transmitted, and a feedback section to which a feedback signal is assigned. The downlink control signal section may be referred to as an assignment section, a scheduling section, a downlink control channel region, and the like. The reference signal transmission section may be referred to as an RS section. The feedback section may be referred to as a report section, an uplink control channel section, an uplink control information transmission section, a HARQ-ACK (A/N) section, a feedback channel region, and the like.

As described above, controlling transmission and reception of signals with establishment of the feedback section in the TTI allows communication in a short time. This assignment is also referred to as self-contained assignment. The TTI to which the self-contained assignment is applied may be referred to as a self-contained TTI. The self-contained assignment may be also referred to as, for example, a self-contained subframe, a self-contained symbol set, or another designation. TDD using the self-contained TTI may be referred to as self-contained TDD or another desgination.

In one self-contained TTI, for example, the UEs and the eNB perform transmission and/or reception of downlink control information, transmission and/or reception of data based on the downlink control information, and transmission and/or reception of specific information (e.g., feedback information in response to the DL transmission). Using the self-contained TTI allows realizing feedback with very short delay of, for example, 1 ms or less, thus eliminating the need for conventional scheduling limitations and a HARQ feedback timing control.

The TTI structure of FIG. 6A can be used as a TTI structure to which the RS resources are dynamically assigned. In the structure, the first symbol of the TTI constitutes the downlink control signal section, the second symbol constitutes a GP, the third to twelfth symbols constitute the RS section, the thirteenth symbol constitutes another GP, and the fourteenth symbol constitutes the feedback section. As a matter of course, the number of symbols of each transmission section is not limited thereto, but is arbitrarily changeable.

The downlink control information to be transmitted to the UEs (UE#1 to #10) in the downlink control signal section includes information related to transmission processing of the reference signals. For example, a radio base station can add information (e.g., resource identifiers) related to reference signal resources (RS resources) to the downlink control information. The resource identifier of the reference signal is information (any of time, a frequency, and a code, a combination of a part or all thereof, and the like) related to the resource of the reference signal that each user terminal intends to transmit.

The radio base station may add identification information (IDs) of users that are commanded to transmit the reference signals to the downlink control information. For example, the downlink control information can be transmitted while being scrambled with the user IDs that are commanded to transmit the reference signals. In other words, the radio base station can individually designate the RS resource for each user terminal. In FIG. 6A, the fifth symbol is individually assigned to the UE#3.

The downlink control information may include information related to the TTI structure (for example, at least one of section lengths (the lengths of the downlink control signal section, the RS section, the feedback section, and the GPs) and the amount of a radio resource used in at least one of the sections). As information related to the section length, there are, for example, the first symbol, last symbol, symbol number, symbol length, and the like of each section. The downlink control information may include information related to signal transmission processing (for example, modulation, demodulation, precoding, scramble identifier, transmission power, and the like). When using a SRS as the reference signal, the downlink control information may include a transmission condition of the reference signal (e.g., SRS).

The UE#1 to #10 receive the downlink control signal in the downlink control signal section, and control transmission of the reference signals based on the downlink control signal. For example, each of the UE#1 to #10 transmits the reference signal in at least a part of the RS section (for example, one or a plurality of symbols) based on the downlink control information. In FIG. 6A, the radio base station controls assignment such that the UE#1 to #10 transmit the reference signals in the third to twelfth symbols of the RS section, respectively.

The user terminals transmit A/N corresponding to reception states of the downlink control signal in the feedback section. Establishing the RS section and the feedback section for transmitting the uplink control signal in the same TTI allows a reduction in delay of the uplink control information.

The TTI depicted in FIG. 6B includes a downlink control signal section to which a downlink control signal is assigned, a measurement section for performing measurement of reception power and the like, and a feedback section to which a feedback signal is assigned. The downlink control signal section may be referred to as an assignment section, a scheduling section, a downlink control channel region, and the like. The measurement section may be referred to as an MR section. The feedback section may be referred to as a report section, an uplink control channel section, an uplink control information transmission section, a HARQ-ACK (A/N) section, a feedback channel region, and the like.

The TTI structure of FIG. 6B can be used as a TTI structure to which the measurement resource (MR) is dynamically assigned. In the structure, a first symbol of the TTI constitutes the downlink control signal section, a second symbol constitutes a GP, third to twelfth symbols constitute the MR section, a thirteenth symbol constitutes another GP, and a fourteenth symbol constitutes the feedback section. As a matter of course, the number of symbols of each transmission section is not limited thereto, but is arbitrarily changeable.

The downlink control information to be transmitted to UEs (e.g., UEs next to the UE#1 to #10) in the downlink control signal section includes information related to measurement processing of the reference signals. For example, a radio base station can add information (e.g., resource identifiers of the reference signals for measurement) related to the measurement resource (MR) to the downlink control information. The resource identifier of the reference signal for measurement is information (any of time, a frequency, and a code, a combination of a part or all thereof, and the like) related to the resource of the reference signal that the user terminal intends to measure.

The identifier of the MR may be determined so as to correspond to the identifiers of the resources (RS resources) of the reference signals to be transmitted in the RS section of FIG. 6A. In other words, the MR designated to the user terminals is provided so as to straddle the plurality of RS resources of the reference signals.

The radio base station may add identification information (IDs) of users (or a user group) that are commanded to perform measurement to the downlink control information. For example, the downlink control information can be transmitted while being scrambled with the user IDs (or user group ID) that are commanded to perform measurement. In other words, the radio base station can provide the common MR for the plurality of user terminals.

The downlink control information may include information related to the TTI structure (for example, at least one of section lengths (the lengths of the downlink control signal section, the MR section, the feedback section, and the GPs) and the amount of a radio resource used in at least one of the sections). The downlink control information may include information related to signal reception processing (for example, modulation, demodulation, precoding, scramble identifier, transmission power, and the like).

The user terminals receive the downlink control signal in the downlink control signal section, and control measurement of the reference signals based on the downlink control signal. For example, the user terminals perform measurement processing in the MR section, which is constituted of the plurality of symbols, based on the downlink control information. In FIG. 6B, the radio base station commands the individual user terminals to measure the reference signals in the third to twelfth symbols constituting the MR section. The radio base station may designate measurement (MR) in a specific symbol in the MR section for each user terminal.

The user terminals that have performed the measurement processing in the MR section can transmit a measurement result (UPI) in the feedback section as uplink control information. The uplink control information (UPI) includes at least one type of information related to the resource identifier of the reference signal, the power of the reception signal (an interference level or a reception level), the uplink traffic amount of the user terminal, and the identifier (user ID) of the user terminal. The user terminal may further feed back at least one of the user identifier, cell ID, and cell group ID of the received reference signal, in addition to the resource identifier of the reference signal.

For example, the user terminals transmit a resource identifier, user identifier, cell ID, cell group ID, and reception level of a reference signal the reception power of which is equal to or more than an established value, out of the reference signals received in the MR section, as part of the uplink control information. The user terminals transmit the measurement result in the feedback section included in the TTI to which the MR is assigned.

The user terminals may transmit the measurement result in another TTI (e.g., next TTI) a certain period (a plurality of TTI lengths) apart from the TTI to which the MR is assigned. For example, when using a short TTI having a TTI length shorter than 1 ms, the certain period may be set at 1 ms. In this case, since the measurement result is reported within 1 ms (existing subframe) from the MR, the user terminals can report the measurement result in a dynamic manner, as compared with existing systems.

The radio base station can grasp interference states of the user terminals (for example, which UE exerts an influence, and the like) to which the MR is applied. Thus, the radio base station can control interference coordination in a dynamic manner, by grasping interferences of the user terminals exerted by other user terminals. As a result, even when UL or DL is controlled in a dynamic manner, it is possible to appropriately reduce interference in the user terminals.

<Second Aspect>

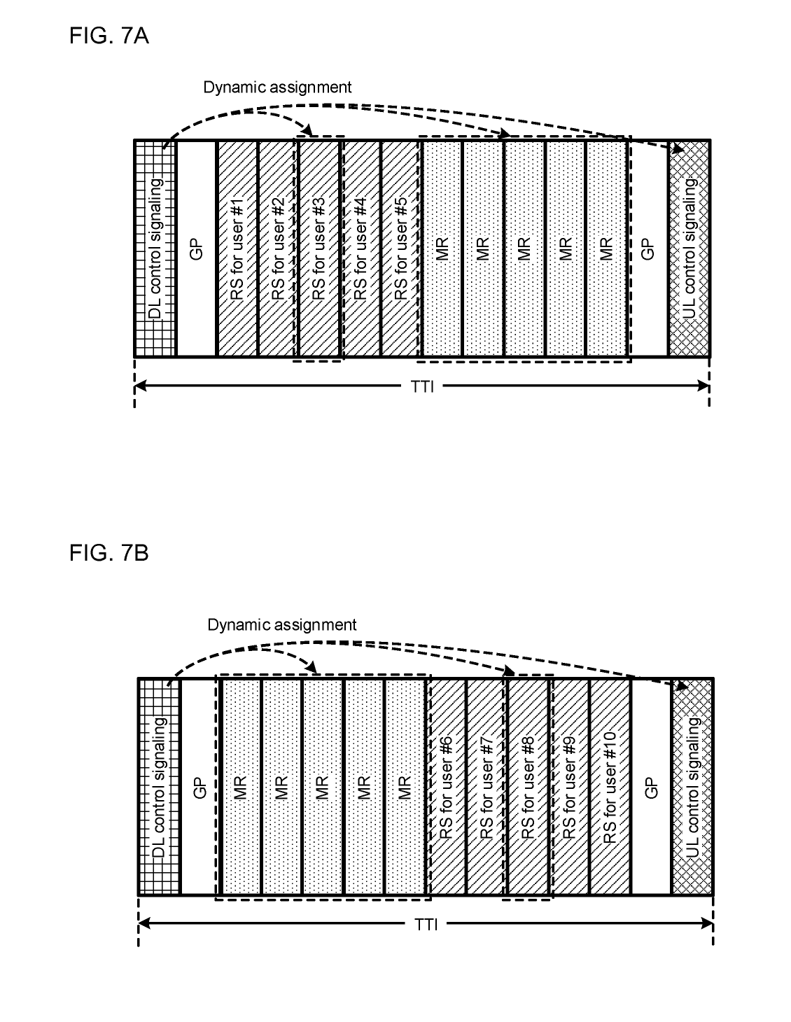

FIGS. 7A and 7B depict an example of a method for assigning both of RS resources and an MR to each user terminal in a certain TTI. In FIG. 7A, a first radio base station (first site) assigns RS resources and an MR to user terminals (UE#1 to #5) in the same TTI. In FIG. 7B, a second radio base station (second site) assigns RS resources and an MR to other user terminals (UE#6 to #10) in the same TTI.

In FIGS. 7A and 7B, the RS resources assigned to the UE#1 to #5 correspond to the MR assigned to the UE#6 to #10, while the MR assigned to the UE#1 to #5 correspond to the RS resources assigned to the UE#6 to #10. The RS resources and the MR are assigned in a time-shared manner in FIGS. 7A and 7B, but not limited thereto, may be assigned in a frequency division manner, or in a combination of time-shared and frequency division manner.

The TTI depicted in FIG. 7A includes a downlink control signal section to which a downlink control signal is assigned, an RS section in which reference signals are transmitted, an MR section for performing measurement of reception power and the like, and a feedback section to which a feedback signal is assigned.

To be more specific, in the TTI structure of FIG. 7A, the first symbol of the TTI constitutes the downlink control signal section, the second symbol constitutes a GP, the third to seventh symbols constitute the RS section, the eighth to twelfth symbols constitute the MR section, the thirteenth symbol constitutes another GP, and the fourteenth symbol constitutes the feedback section. As a matter of course, the number of symbols of each transmission section is not limited thereto, but is arbitrarily changeable.

Downlink control information transmitted to the UEs (UE#1 to #5) in the downlink control signal section includes information related to the reference signal resources (RS resources) and information related to the measurement resource (MR). The information related to the RS resources is the same as that of FIG. 6A. The information related to the MR is the same as that of FIG. 6B.

In the TTI structure of FIG. 7B, the first symbol of the TTI constitutes a downlink control signal section, the second symbol constitutes a GP, the third to seventh symbols constitute an MR section, the eighth to twelfth symbols constitute an RS section, the thirteenth symbol constitutes another GP, and the fourteenth symbol constitutes a feedback section. As a matter of course, the number of symbols of each transmission section is not limited thereto, but is arbitrarily changeable.

Downlink control information transmitted to the UEs (UE#6 to #10) in the downlink control signal section includes information related to the reference signal resources (RS resources) and information related to the measurement resource (MR). The information related to the RS resources is the same as that of FIG. 6A. The information related to the MR is the same as that of FIG. 6B.

The radio base stations can designate an individual RS resource (e.g., one symbol) to each user terminal. The radio base stations can designate an MR (e.g., a plurality of symbols) to each user terminal.

In FIG. 7A, the first radio base station designates the fifth symbol to UE#3 as an RS resource, and designates the eighth to twelfth symbols to UE#3, in common with other UEs, as an MR. UE#3 transmits a reference signal in the fifth symbol, and performs measurement of reference signals transmitted from other UEs (UE#6 to #10) in the eighth to twelfth symbols.

In FIG. 7B, the second radio base station designates the third to seventh symbols to UE#8, in common with other UEs, as an MR, and individually designates the tenth symbol to the UE#8 as an RS resource. UE#8 performs measurement of reference signals transmitted from other UEs (UE#1 to #5) in the third to seventh symbols, and transmits a reference signal in the tenth symbol.

The user terminals that have performed measurement processing in the MR section transmit a measurement result (UPI) in the feedback section as uplink control information. The uplink control information (UPI) is the same as that of FIG. 6B.

In FIG. 7A, the UE#1 to #5 transmit a measurement result of the reference signals, which are transmitted from the other UEs (UE#6 to #10) in the MR section (eighth to twelfth symbols), to the first radio base station in the feedback section of the same TTI or a feedback section of another TTI a certain period apart from the TTI. In FIG. 7B, the UE#6 to #10 transmit a measurement result of the reference signals, which are transmitted from the other UEs (UE#1 to #5) in the MR section (third to seventh symbols), to the second radio base station in the feedback section of the same TTI or a feedback section of another TTI a certain period apart from the TTI.

The radio base station can grasp an interference state of each user terminal (for example, which UE exerts an influence, and the like). Thus, each radio base station can control interference coordination in a dynamic manner, by grasping an interference of the user terminal exerted by another user terminal. As a result, even when UL or DL is controlled in a dynamic manner, it is possible to appropriately reduce interference in the user terminal.

<Third Aspect>

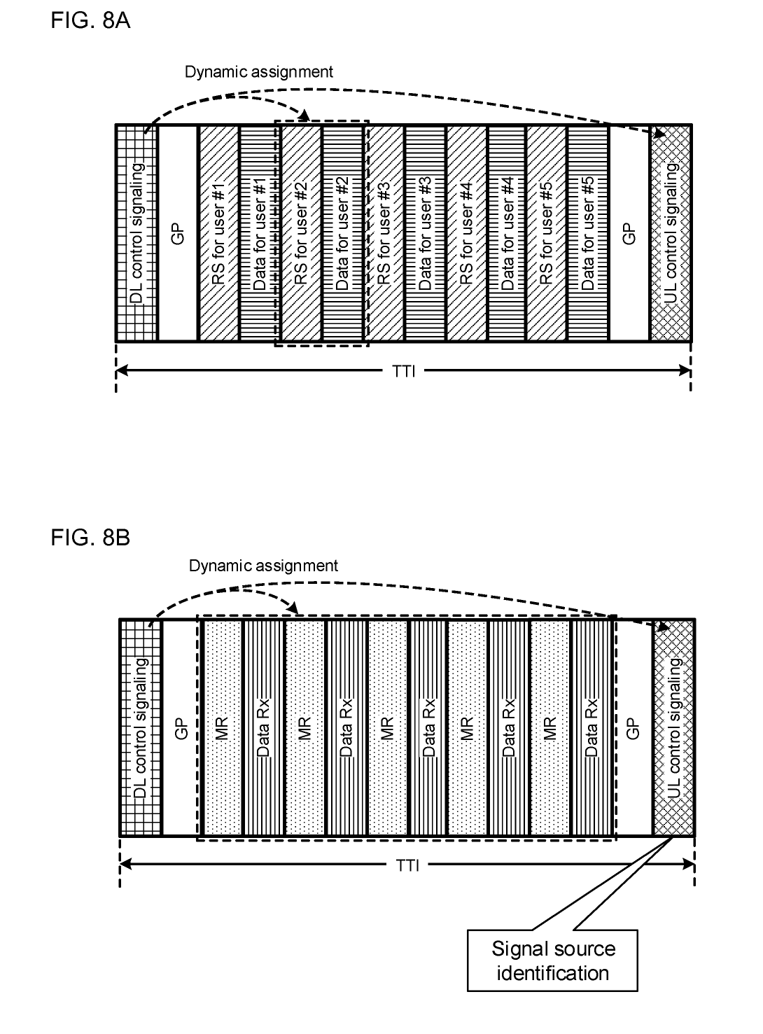

FIGS. 8A and 8B depict an example of a method for assigning reference signal transmission resources (RS resources) and a measurement resource (MR) in a certain TTI.

In FIG. 8A, a first radio base station (first site) assigns RS resources and data transmission resources to user terminals (UE#1 to #5). In FIG. 8B, a second radio base station (second site) assigns an MR and a data reception resource to other user terminals.

In FIGS. 8A and 8B, the RS resources assigned to the UE#1 to #5 correspond to the MR assigned to the UE#6 to #10, while the data transmission resources assigned to the UE#1 to #5 correspond to the data reception resource assigned to the UE#6 to #10. The RS resources and the data transmission resources (MR and data reception resource) are assigned in a time-shared manner in FIGS. 8A and 8B, but not limited thereto, may be assigned in a frequency division manner, or in a combination of time-shared and frequency division manner.

The TTI depicted in FIG. 8A includes a downlink control signal section to which a downlink control signal is assigned, a reference signal transmission section in which reference signals are transmitted, a data transmission section for performing data transmission, and a feedback section to which a feedback signal is assigned. The TTI depicted in FIG. 8B includes a downlink control signal section to which a downlink control signal is assigned, an MR section for performing measurement of reception power and the like, a data reception section for performing data reception, and a feedback section to which a feedback signal is assigned.

To be more specific, in the TTI structure of FIG. 8A, the first symbol of the TTI constitutes the downlink control signal section, the second symbol constitutes a GP, the third, fifth, seventh, ninth, and eleventh symbols constitute the RS section, the fourth, sixth, eighth, tenth, and twelfth symbols constitute the data transmission section, the thirteenth symbol constitutes another GP, and the fourteenth symbol constitutes the feedback section. As a matter of course, the number of symbols of each transmission section is not limited thereto, but is arbitrarily changeable.

Downlink control information transmitted to UEs (UE#1 to #5) in the downlink control signal section includes information related to the reference signal resources (RS resources) and information related to data transmission orders. The information related to the RS resources is the same as that of FIG. 6A.

The first radio base station individually designates the RS resource and the data transmission resource to each of the user terminals (UE#1 to #5). In FIG. 8A, the first radio base station designates the fifth symbol to UE#2 as an RS resource, and designates the sixth symbol to UE#2 as a data transmission resource. UE#2 transmits a reference signal in the fifth symbol, and transmits data in the sixth symbol. The user terminal can add a user identifier and/or a cell ID to the transmission data.

The data transmission resource is disposed after the RS resource in FIG. 8A, but a disposition order of the RS resource and the data transmission resource may be opposite. The RS resource and the data transmission resource may be disposed in locations a certain number of symbols apart from each other, instead of symbols next to each other.

In the TTI structure of FIG. 8B, the first symbol of the TTI constitutes the downlink control signal section, the second symbol constitutes a GP, the third, fifth, seventh, ninth, and eleventh symbols constitute the MR section, the fourth, sixth, eighth, tenth, and twelfth symbols constitute the data reception section, the thirteenth symbol constitutes another GP, and the fourteenth symbol constitutes the feedback section. As a matter of course, the number of symbols of each transmission section is not limited thereto, but is arbitrarily changeable.

Downlink control information transmitted to UEs (UEs next to the UE#1 to #5) in the downlink control signal section includes information related to the measurement resource (MR) and information related to data reception orders. The information related to the MR is the same as that of FIG. 6B. Reception data may be transmitted not only from the radio base station, but from another user terminal as well.

The radio base station designates the MR and the data reception resource in common with the user terminals. In FIG. 8B, the second radio base station designates the third, fifth, seventh, ninth, and eleventh symbols to the user terminals (or a user group) as an MR, and designates the fourth, sixth, eighth, tenth, and twelfth symbols to the user terminals as a data reception resource. Since the MR and the data reception resources are provided in the same TTI, it is possible to demodulate data signals with high precision using RS received on the MR even in a fast-moving environment.

The user terminals that have performed measurement processing in the MR section transmit a measurement result (UPI) in the feedback section as uplink control information. The uplink control information (UPI) is the same as that of FIG. 6B.

In FIG. 8B, the user terminals that have measured the reference signals, which are transmitted from the other UEs (UE#1 to #5) in the MR section, transmit a measurement result to the radio base station in the feedback section of the same TTI or a feedback section of another TTI a certain period apart from the TTI.

The radio base station can grasp an interference state of each user terminal (for example, which UE exerts an influence, and the like). Thus, each radio base station can control interference coordination in a dynamic manner, by grasping an interference of the user terminal exerted by another user terminal. As a result, even when UL or DL is controlled in a dynamic manner, it is possible to appropriately reduce interference in the user terminal.

(Radio Communication System)

The configuration of a radio communication system according to an embodiment of the present invention will be described below. The radio communication system performs communication using any of the radio communication methods according to the above aspects of the present invention or a combination thereof.

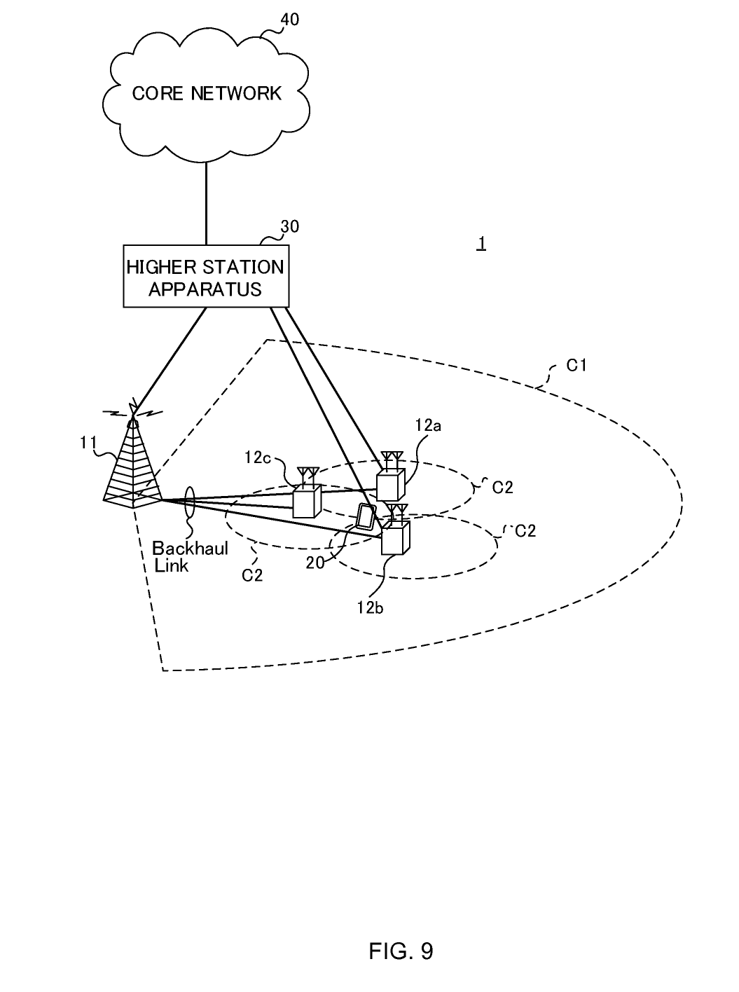

FIG. 9 is a drawing depicting an example of the schematic configuration of the radio communication system according to the embodiment of the present invention. A radio communication system 1 applies Carrier Aggregation (CA) and/or Dual Connectivity (DC) to aggregate multiple basic frequency blocks (component carriers) in units of system bandwidths (e.g., 20 MHz) of LTE systems.

The radio communication system 1 may be also referred to as LTE (Long Term Evolution), LTE-A (LTE-Advance), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), and the like, and a system to realize the scheme.

As depicted in FIG. 9, the radio communication system 1 includes a radio base station 11 for forming a macro cell C1 having relatively large coverage, and radio base stations 12 (12a to 12c) that are disposed in the macro cell C1 and form cells C2 smaller than the macro cell C1. A user terminal 20 is disposed in the macro cell C1 and the small cells C2.

The user terminal 20 can be connected to both of the radio base station 11 and the radio base stations 12. The user terminal 20 is assumed to concurrently use the macro cell C1 and the small cells C2 by CA or DC. CA or DC may be applied to the user terminal 20 using multiple cells (CCs) (for example, five or less CCs, or six or more CCs).

The user terminal 20 can communicate with the radio base station 11 using a narrow band carrier (an existing carrier, a legacy carrier, and the like) in a relatively low frequency band (e.g., 2 GHz). On the other hand, the user terminal 20 may communicate with the radio base station 12 using a wide band carrier in a relatively high frequency band (for example, 3.5 GHz, 5 GHz, and the like), or using the same carrier as for the radio base station 11. The frequency band used by each radio base station is not limited thereto.

The radio base station 11 and the radio base station 12 (or the two radio base stations 12) are connected with a wire (e.g., a CPRI (Common Public Radio Interface)-compliant optical fiber, an X2 interface, and the like), or connected wirelessly.

Each of the radio base stations 11 and 12 is connected to a higher station apparatus 30, and connected to a core network 40 through the higher station apparatus 30. The higher station apparatus 30 includes, for example, an access gateway device, a radio network controller (RNC), a mobility management entity (MME), and the like, but is not limited thereto. Each radio base station 12 may be connected to the higher station apparatus 30 through the radio base station 11.

The radio base station 11 is a radio base station having relatively large coverage, and may be also referred to as a macro base station, an aggregation node, an eNB (eNodeB), a transmission and reception point, and the like. The radio base station 12 is a radio base station having local coverage, and may be also referred to as a small base station, a micro base station, a pico base station, a femto base station, an HeNB (Home eNodeB), an RRH (remote radio head), a transmission and reception point, and the like. The radio base stations 11 and 12 are collectively called radio base stations 10, when not distinguishing therebetween.

The user terminal 20 is a terminal compliant to various communication schemes such as LTE and LTE-A, and may include a stationary communication terminal (fixed station), as well as a mobile communication terminal (mobile station).

In the radio communication system 1, Orthogonal Frequency Division Multiple Access (OFDMA) is applied to a downlink, while Single Carrier Frequency Division Multiple Access (SC-FDMA) is applied to an uplink, as radio access schemes.

OFDMA is a multicarrier transmission scheme in which a frequency band is divided into multiple narrow frequency bands (subcarriers) and communication is performed by mapping data to the subcarriers. SC-FDMA is a single carrier transmission scheme in which a system bandwidth is divided on a terminal-by-terminal basis into bands each of which is constituted of one or continuous resource blocks, and a plurality of terminals use the different bands from each other in order to prevent interference between the terminals. The uplink and downlink radio access schemes are not limited to this combination, and other radio access schemes may be used instead.

The radio communication system 1 uses a physical downlink shared channel (PDSCH) shared among the user terminals 20, a physical broadcast channel (PBCH), a downlink L1/L2 control channel, and the like, as downlink channels. The PDSCH carries user data, higher layer control information, SIBs (system information blocks), and the like. The PBCH carries an MIB (master information block).

The downlink L1/L2 control channel includes a PDCCH (physical downlink control channel), an EPDCCH (enhanced physical downlink control channel), a PCFICH (physical control format indicator channel), a PHICH (physical hybrid-ARQ indicator channel), and the like. The PDCCH carries DCI (downlink control information) including scheduling information about the PDSCH and a PUSCH, and the like. The PCFICH carries the number of OFDM symbols used in the PDCCH. The PHICH carries HARQ (hybrid automatic repeat request) delivery confirmation information (e.g., retransmission control information, HARQ-ACK, ACK/NACK, and the like) in response to the PUSCH. The EPDCCH is frequency division multiplexed with the PDSCH (downlink shared data channel), and carries the DCI and the like, just as with the PDCCH.

The radio communication system 1 uses a physical uplink shared channel (PUSCH) shared among the user terminals 20, a physical uplink control channel (PUCCH), a physical random access channel (PRACH), and the like, as uplink channels. The PUSCH carries user data, higher layer control information, and the like. The PUCCH carries downlink radio quality information (channel quality indicator (CQI)), delivery confirmation information, and the like. The PRACH carries random access preambles to establish connection with cells.

In the radio communication system 1, a cell-specific reference signal (CRS), a channel state information-reference signal (CSI-RS), a demodulation reference signal (DMRS), a positioning reference signal (PRS), and the like are transmitted as downlink reference signals. In the radio communication system 1, a sounding reference signal (SRS), a demodulation reference signal (DMRS), and the like are transmitted as uplink reference signals. The DMRS may be referred to as a UE-specific reference signal. The reference signals to be transmitted are not limited thereto.

(Radio Base Station)

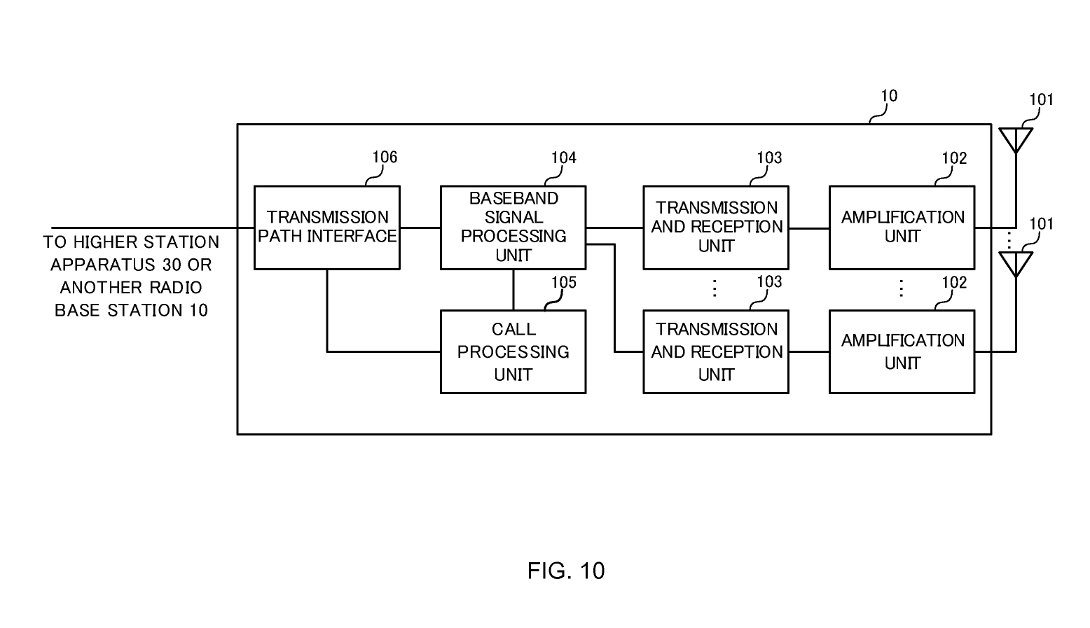

FIG. 10 is a drawing depicting an example of the entire configuration of the radio base station according to an embodiment of the present invention. The radio base station 10 includes transmission and reception antennas 101, amplification units 102, transmission and reception units 103, a baseband signal processing unit 104, a call processing unit 105, and a transmission path interface 106. The number of each of the transmission and reception antennas 101, the amplification units 102, and the transmission and reception units 103 may be one or more.

User data to be transmitted from the radio base station 10 to the user terminal 20 on a downlink is inputted from the higher station apparatus 30 to the baseband signal processing unit 104 through the transmission path interface 106.

The baseband signal processing unit 104 applies transmission processing, which includes PDCP (packet data convergence protocol) layer processing, the division and coupling of user data, RLC (radio link control) layer transmission processing such as RLC retransmission control, MAC (medium access control) retransmission control (e.g., HARQ transmission processing), scheduling, a choice of a transmission format, channel encoding, inverse fast Fourier transform (IFFT) processing, precoding, and the like, to the user data, and transfers the processed user data to the transmission and reception unit 103. The baseband signal processing unit 104 also applies transmission processing including channel encoding, IFFT processing, and the like to a downlink control signal, and transfers the processed downlink control signal to the transmission and reception unit 103.

The transmission and reception unit 103 converts the baseband signal, which is pre-coded and outputted from the baseband signal processing unit 104 on an antenna-by-antenna basis, into a signal in a radio frequency band, and transmits the converted signal. The radio frequency signal that is frequency-converted by the transmission and reception unit 103 is amplified by the amplification unit 102, and transmitted from the transmission and reception antenna 101. The transmission and reception unit 103 may be constituted of an integral transceiver unit, or a transmission unit and a reception unit.

As for an uplink signal, a radio frequency signal received by the transmission and reception antenna 101 is amplified by the amplification unit 102. The transmission and reception unit 103 receives the uplink signal amplified by the amplification unit 102. The transmission and reception unit 103 frequency-converts the reception signal into a baseband signal, and outputs the baseband signal to the baseband signal processing unit 104.

The baseband signal processing unit 104 applies fast Fourier transform (FFT) processing, inverse discrete Fourier transform (IDFT) processing, error correction decoding, reception processing for MAC retransmission control, and reception processing of a PLC layer and a PDCP layer to user data included in the inputted uplink signal. The processed uplink signal is transferred to the higher station apparatus 30 through the transmission path interface 106. The call processing unit 105 performs call processing such as settings and release of transmission channels, state management of the radio base station 10, and management of radio resources.

The transmission path interface 106 transmits and receives signals to and from the higher station apparatus 30 through a certain interface. The transmission path interface 106 may transmit and receive signals (by backhaul signaling) to and from another radio base station 10 through an interface (e.g., a CPRI (common public radio interface)-compliant optical fiber or an X2 interface) between the radio base stations.

The transmission and reception unit 103 transmits DCI related to data transmission and/or reception to the user terminal 20 in a downlink control signal section determined by a control unit 301. For example, the transmission and reception unit 103 transmits information (e.g., a resource identifier of a reference signal) related to a transmission section (RS resource) and a measurement section (MR) of a reference signal to the user terminal 20. The transmission and reception unit 103 also receives a result of a user terminal's measurement of a signal of another user terminal using a measurement resource.

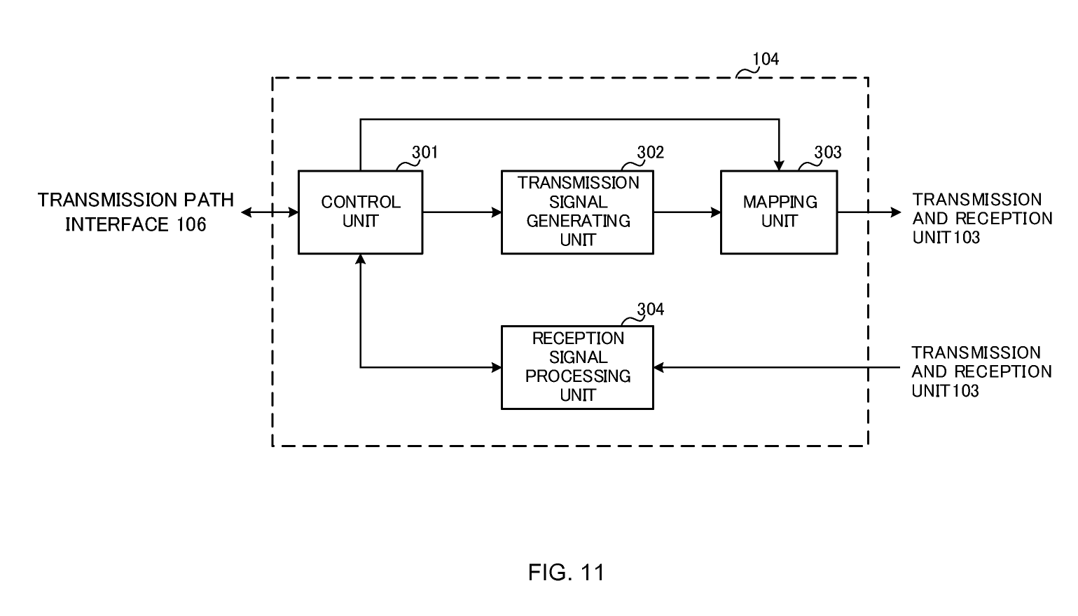

FIG. 11 is a drawing depicting an example of the functional configuration of a radio base station according to an embodiment of the present invention. FIG. 11 mainly depicts functional blocks that are features of the embodiment, and the radio base station 10 has other functional blocks required for radio communication. As depicted in FIG. 11, the baseband signal processing unit 104 includes at least the control unit (scheduler) 301, a transmission signal generation unit 302, a mapping unit 303, a reception signal processing unit 304, and a measurement unit 305.

The control unit (scheduler) 301 controls the entire radio base station 10. The control unit 301 is constituted of a controller, a control circuit, or a control device that is described based on common knowledge in the technical art of the present invention.

The control unit 301 controls, for example, generation of signals by the transmission signal generation unit 302, and allocation of the signals by the mapping unit 303. The control unit 301 also controls reception processing of signals by the reception signal processing unit 304, and measurement of the signals by the measurement unit 305.

The control unit 301 controls dynamic assignments of a measurement resource (MR) and/or reference signal transmission resources (RS resources) to user terminals. For example, the control unit 301 designates an MR resource and/or RS resources by downlink control information included in the same TTI. The control unit 301 commands the user terminals to transmit information related to a measurement result in a different symbol of the TTI that includes the MR and/or the RS resources.

The control unit 301 may control assignments of the MR and the RS resources to different symbols of the same TTI. The control unit 301 may control assignments of the MR and a data reception resource to the same TTI, and control assignments of the RS resources and data transmission resources to the same TTI.

The transmission signal generation unit 302 generates downlink signals (downlink control signals, downlink data signals, downlink reference signals, and the like) based on commands from the control unit 301, and outputs the downlink signals to the mapping unit 303. The transmission signal generation unit 302 is constituted of a signal generator, a signal generation circuit, or a signal generation device that is described based on common knowledge in the technical art of the present invention.

For example, the transmission signal generation unit 302 generates a DL assignment indicating assignment information of the downlink signals and an UL grant indicating assignment information of uplink signals, based on commands from the control unit 301. Coding processing and modulation processing are applied to downlink data signals in accordance with a coding ratio, a modulation scheme, and the like determined based on channel state information (CSI) and the like from each user terminal 20.

The mapping unit 303 maps the downlink signals generated by the transmission signal generation unit 302 to certain radio resources based on commands from the control unit 301, and outputs the mapped signals to the transmission and reception unit 103. The mapping unit 303 is constituted of a mapper, a mapping circuit, or a mapping device that is described based on common knowledge in the technical art of the present invention.

The reception signal processing unit 304 applies reception processing (for example, demapping, demodulation, decoding, and the like) to reception signals inputted from the transmission and reception units 103. The reception signals are, for example, uplink signals (uplink control signals, uplink data signals, uplink reference signals, and the like) transmitted from the user terminals 20. The reception signal processing unit 304 is constituted of a signal processor, a signal processing circuit, or a signal processing device that is described based on common knowledge in the technical art of the present invention.

The reception signal processing unit 304 outputs the information decoded by the reception processing to the control unit 301. For example, when receiving the PUCCH including HARQ-ACK, the reception signal processing unit 304 outputs the HARQ-ACK to the control unit 301. The reception signal processing unit 304 outputs the reception signals and the signals after the reception processing to the measurement unit 305.

The measurement unit 305 performs measurement on the received signals. The measurement unit 305 is constituted of a measurement instrument, a measurement circuit, or a measurement device that is described based on common knowledge in the technical art of the present invention.

The measurement unit 305 may measure reception power (e.g., RSRP (reference signal received power)), reception quality (e.g., RSRQ (reference signal received quality)), a channel state, and the like of the received signal. Measurement results may be outputted to the control unit 301.

(User Terminal)

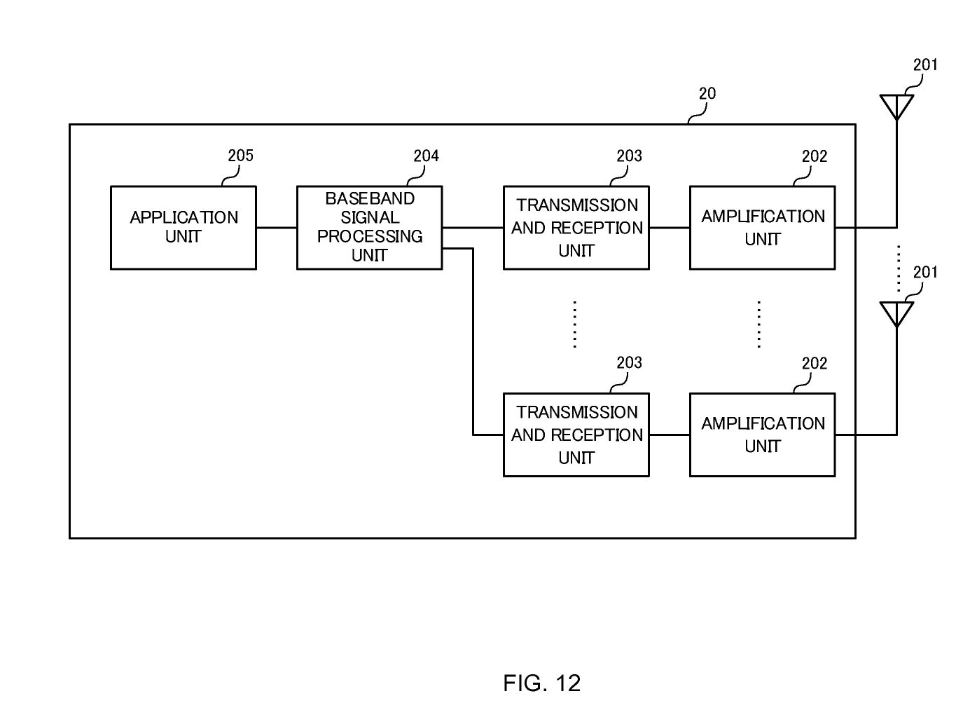

FIG. 12 is a drawing depicting an example of the entire configuration of a user terminal according to an embodiment of the present invention. The user terminal 20 includes transmission and reception antennas 201, amplification units 202, and transmission and reception units 203, a baseband signal processing unit 204, and an application unit 205. The number of each of the transmission and reception antennas 201, the amplification units 202, and the transmission and reception units 203 may be one or more.

Radio frequency signals received by the transmission and reception antennas 201 are amplified by the amplification units 202. Each transmission and reception unit 203 receives the downlink signal amplified by the amplification unit 202. The transmission and reception unit 203 frequency-converts the reception signal into a baseband signal, and outputs the baseband signal to the baseband signal processing unit 204. The transmission and reception unit 203 is constituted of a transmitter and a receiver, a transmission and reception circuit, or a transmission and reception device that is described based on common knowledge in the technical art of the present invention. The transmission and reception unit 203 may be constituted of an integral transceiver unit, or a transmission unit and a reception unit.

The baseband signal processing unit 204 applies FFT processing, error correction decoding, reception processing for retransmission control, and the like to the inputted baseband signals. The processed downlink user data is transferred to the application unit 205. The application unit 205 performs processing related to higher layers than a physical layer and a MAC layer, and the like. Broadcast information of the downlink data is also transferred to the application unit 205.

Uplink user data is inputted from the application unit 205 to the baseband signal processing unit 204. The baseband signal processing unit 204 applies transmission processing for retransmission control (e.g., HARQ transmission processing), channel coding, precoding, discrete Fourier transform (DFT) processing, IFFT processing, and the like to the user data, and transfers the processed user data to the transmission and reception unit 203. The transmission and reception unit 203 converts the baseband signal outputted from the baseband signal processing unit 204 into a signal in a radio frequency band, and transmits the converted signal. The radio frequency signal that is frequency-converted by the transmission and reception unit 203 is amplified by the amplification unit 202, and transmitted from the transmission and reception antenna 201.

The transmission and reception unit 203 transmits information about a result of measurement performed in an MR designated by the radio base station. The transmission and reception unit 203 can transmit the information about the measurement result in a different symbol of a TTI that includes the MR. The transmission and reception unit 203 can transmit a reference signal using a dynamically assigned RS resource. For example, the transmission and reception unit 203 transmits a reference signal using an RS resource designated by downlink control information included in the same TTI (see FIG. 6A). The RS resource and the MR may be established in the same TTI (see FIGS. 7A and 7B).

While the transmission and reception unit 203 transmits a reference signal using an RS resource, the transmission and reception unit 203 may transmit uplink data in a different symbol of a TTI that includes the RS resource (see FIG. 8A). While the transmission and reception unit 203 measures a reference signal using an MR, the transmission and reception unit 203 may receive data in a different symbol of a TTI that includes the MR (see FIG. 8B).

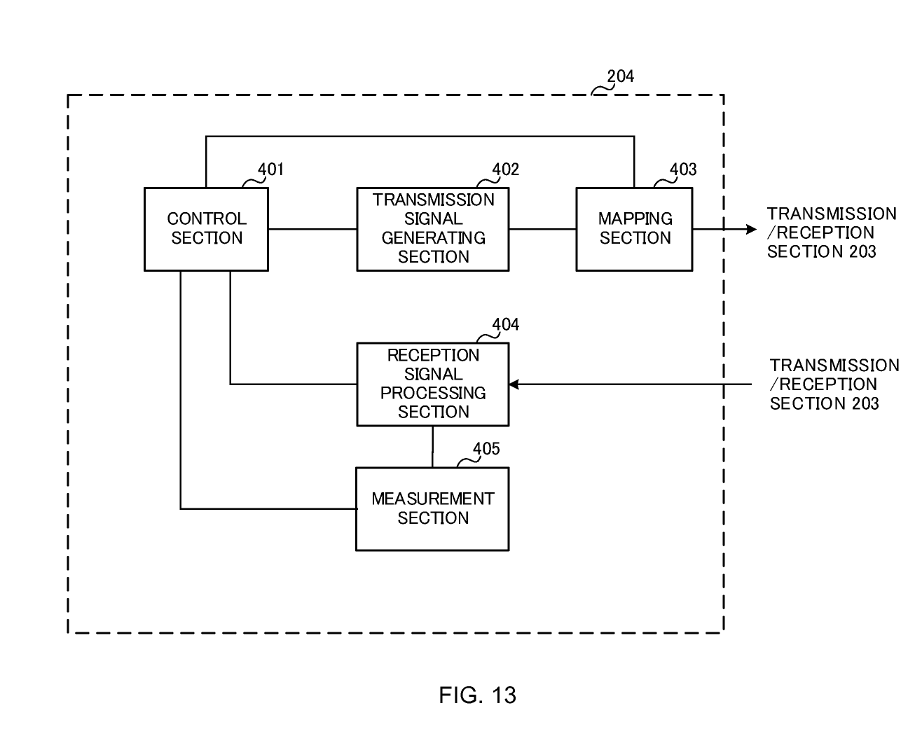

FIG. 13 is a drawing depicting an example of the functional configuration of a user terminal according to an embodiment of the present invention. FIG. 13 mainly depicts functional blocks that are features of the embodiment, and the user terminal 20 has other functional blocks required for radio communication. As depicted in FIG. 13, the baseband signal processing unit 204 includes at least a control unit 401, a transmission signal generation unit 402, a mapping unit 403, a reception signal processing unit 404, and a measurement unit 405.

The control unit 401 controls the entire user terminal 20. The control unit 401 is constituted of a controller, a control circuit, or a control device that is described based on common knowledge in the technical art of the present invention.

The control unit 401 controls, for example, generation of signals by the transmission signal generation unit 402, and assignment of the signals by the mapping unit 403. The control unit 401 also controls signal reception processing performed by the reception signal processing unit 404, and measurement of signals by the measurement unit 405. The control unit 401 controls transmission processing and reception processing performed by the transmission and reception units 203.

The control unit 401 receives downlink control signals (signals transmitted on the PDCCH/EPDCCH) and downlink data signals (signals transmitted on the PDSCH) transmitted from the radio base stations 10 through the reception signal processing unit 404. The control unit 401 controls generation of uplink control signals (e.g., delivery confirmation information and the like) and uplink data signals based on the downlink control signals, determination results of necessity for retransmission control for the downlink data signals, and the like.

When a downlink control signal includes information about an RS resource, the control unit 401 controls transmission processing of a reference signal by the transmission and reception unit 203 based on the information. When a downlink control signal includes information about an MR, the control unit 401 controls measurement processing by the measurement unit 405 based on the information. The control unit 401 controls transmission of a measurement result obtained on the MR in a feedback section of the same TTI or a feedback section of a TTI a certain period apart from the same TTI.

The transmission signal generation unit 402 generates uplink signals (uplink control signals, uplink data signals, uplink reference signals, and the like) based on commands from the control unit 401, and outputs the generated signals to the mapping unit 403. The transmission signal generation unit 402 is constituted of a signal generator, a signal generation circuit, or a signal generation device that is described based on common knowledge in the technical art of the present invention.

For example, the transmission signal generation unit 402 generates uplink control signals related to delivery confirmation information and channel state information (CSI) based on commands from the control unit 401. The transmission signal generation unit 402 also generates uplink data signals based on commands from the control unit 401. For example, when a downlink control signal transmitted from the radio base station 10 includes a UL grant, the control unit 401 commands the transmission signal generation unit 402 to generate an uplink data signal.

The mapping unit 403 maps the uplink signals generated by the transmission signal generation unit 402 to radio resources based on commands from the control unit 401, and outputs the mapped signals to the transmission and reception unit 203. The mapping unit 403 is constituted of a mapper, a mapping circuit, or a mapping device that is described based on common knowledge in the technical art of the present invention.

The reception signal processing unit 404 applies reception processing (for example, demapping, demodulation, decoding, and the like) to reception signals inputted from the transmission and reception units 203. The reception signals are, for example, downlink signals (downlink control signals, downlink data signals, downlink reference signals, and the like) transmitted from the radio base stations 10. The reception signal processing unit 404 is constituted of a signal processor, a signal processing circuit, or a signal processing device that is described based on common knowledge in the technical art of the present invention. The reception signal processing unit 404 constitutes a reception unit according to the present invention.

The reception signal processing unit 404 blind decodes DCI (DCI format) for scheduling transmission and/or reception of data (TB: transport block) based on a command from the control unit 401. For example, the reception signal processing unit 404 may blind decode a different radio resource depending on whether or not self-contained subframes are used.

The reception signal processing unit 404 outputs the information decoded by the reception processing to the control unit 401. The reception signal processing unit 404 outputs, for example, broadcast information, system information, RRC signaling, DCI, and the like to the control unit 401. The reception signal processing unit 404 may output a data decoding result to the control unit 401. The reception signal processing unit 404 also outputs the reception signals and signals after the reception processing to the measurement unit 405.

The measurement unit 405 performs measurement of the received signals. The measurement unit 405 can perform measurement using an MR that is assigned by the radio base station in a dynamic manner. For example, the measurement unit 405 performs measurement in an MR that is designated by downlink control information included in the same TTI. The measurement unit 405 is constituted of a measurement instrument, a measurement circuit, or a measurement device that is described based on common knowledge in the technical art of the present invention.

The measurement unit 405 may measure, for example, reception power (e.g., RSRP), reception quality (e.g., RSRQ), a channel state, and the like of the received signal. Measurement results may be outputted to the control unit 401.

(Hardware Configuration)

The block diagrams used in description of the above embodiments depict functional blocks. The functional blocks (elements) are realized by an arbitrary combination of hardware and/or software. A method for realizing each functional block is not specifically limited. In other words, each functional block may be realized by physically integrated one device, or two or more physically separated devices connected with or without wires.

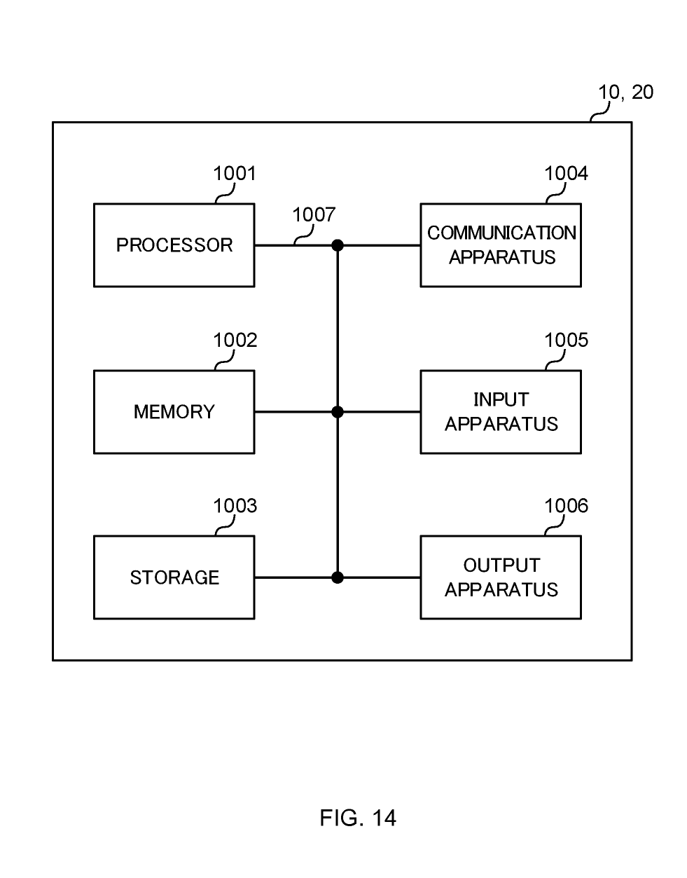

For example, a radio base station, a user terminal, and the like according to an embodiment of the present invention may be realized by computers that perform processing for the radio communication method according to the present invention. FIG. 14 is an example of the hardware configuration of each of the radio base station and the user terminal according to the embodiment of the present invention. Each of the above-described radio base stations 10 and the user terminal 20 may be physically constituted of a computer device that includes a processor 1001, a memory 1002, storage 1003, communication equipment 1004, input equipment 1005, output equipment 1006, a bus 1007, and the like.

In the following description, the term “equipment” may be substituted for “circuit”, “device”, “unit”, and the like. The hardware configuration of each of the radio base stations 10 and the user terminal 20 may include one or a plurality of pieces of the equipment depicted in the drawing, or may not include a part of the equipment.

In order to achieve each function of the radio base stations 10 and the user terminal 20, the processor 1001 performs operation so as to control communication by the communication equipment 1004 and reading and/or writing of data from and/or to the memory 1002 and the storage 1003, by loading specific software (programs) into hardware such as the processor 1001 and the memory 1002.

The processor 1001 controls the entire computer by executing, for example, an operating system. The processor 1001 may be constituted of a central processing unit (CPU) including an interface with peripheral equipment, a control unit, an arithmetic unit, a resistor, and the like. For example, the above baseband signal processing unit 104 (204), call processing unit 105, and the like may be realized by the processor 1001.

The processor 1001 loads programs (program code), software modules, and data from the storage 1003 and/or the communication equipment 1004 into the memory 1002, and executes various types of processing in accordance therewith. As the programs, programs that make the computer execute at least a part of the operations described in the above embodiments are used. For example, the control unit 401 of the user terminal 20 may be stored in the memory 1002, and realized by a control program executed by the processor 1001. The same goes for the other functional blocks.

The memory 1002 is a computer-readable recording medium, and may be constituted of, for example, at least one of a ROM (read-only memory), an EPROM (erasable programmable ROM), a RAM (random access memory), and the like. The memory 1002 may be referred to as a resistor, a cache, a main memory (main storage), and the like. The memory 1002 can store programs (program code), software modules, and the like that are to be executed to perform the radio communication method according to the embodiment of the present invention.

The storage 1003 is a computer-readable recording medium, and may be constituted of, for example, at least one of an optical disk such as a CD-ROM (compact disc ROM), a hard disk drive, a flexible disk, a magneto-optical disk, a flash memory, and the like. The storage 1003 may be referred to as auxiliary storage.

The communication equipment 1004 is hardware (a transmission and reception device) to establish communication between computers through a wired and/or wireless network. The communication equipment 1004 is also referred to as, for example, a network device, a network controller, a network card, a communication module, and the like. For example, the above transmission and reception antenna 101 (201), amplification unit 102 (202), transmission and reception unit 103 (203), transmission path interface 106, and the like may be realized by the communication equipment 1004.

The input equipment 1005 is an input device (e.g., keyboard, mouse, and the like) that receives input from the outside. The output equipment 1006 is an output device (e.g., display, speaker, and the like) that performs external output. The input equipment 1005 and the output equipment 1006 may be integrated (into, e.g., a touch panel).

Each piece of the equipment such as the processor 1001 and the memory 1002 is connected through the bus 1007 to communicate information. The bus 1007 may be constituted of a single bus, or buses which are different from one piece of equipment to another.

Each of the radio base stations 10 and the user terminal 20 may include hardware such as a microprocessor, a digital signal processor (DSP), an ASIC (application specific integrated circuit), a PLD (programmable logic device), and an FPGA (field programmable gate array). The hardware may realize a part or all of each functional block. For example, the processor 1001 may be constituted of at least one piece of the hardware.

The terms described in this application and/or the terms required for understanding this application may be substituted with other terms that refer to the same or similar meanings. For example, “channel” and/or “symbol” may be substituted with “signal (signaling)”. “Signal” may be substituted with “message”. “Component carrier (CC)” may be substituted with “cell”, “frequency carrier”, “carrier frequency”, and the like.

A radio frame may include one or a plurality of periods (frames) in a time domain. The one or each of the plurality of periods (frames) included in the radio frame may be referred to as a subframe. The subframe may include one or a plurality of slots in the time domain. Each slot may include one or a plurality of symbols (OFDM symbols, SC-FDMA symbols, or the like) in the time domain.

The radio frame, the subframe, the slot, and the symbol represent time units in transmitting signals. Each of the radio frame, the subframe, the slot, and the symbol may be referred to as another designation. For example, one subframe may be referred to as a transmission time interval (TTI), a plurality of continuous subframes may be referred to as a TTI, or one slot may be referred to as a TTI. In other words, the TTI may denote a subframe (1 ms) in existing LTE, a period shorter (e.g., 1 to 13 symbols) than 1 ms, or a period longer than 1 ms.

The TTI denotes, for example, a minimum time unit for scheduling in radio communication. For example, in scheduling by LTE systems, the radio base station assigns radio resources (frequency bandwidths, transmission power, and the like usable in each user terminal) to each user terminal in units of TTI. The definitions of the TTI are not limited thereto.

A TTI having a time length of 1 ms may be referred to as a common TTI (TTI in LTE Releases 8 to 12), a normal TTI, a long TTI, a common subframe, a normal subframe, a long subframe, and the like. A shorter TTI than the common TTI may be referred to as a shortened TTI, a short TTI, a shortened subframe, a short subframe, and the like.

A resource block (RB) is a resource assignment unit in a time domain and a frequency domain, and may include one or a plurality of continuous subcarriers. The RB may include one or a plurality of symbols in the time domain, and have a length of one slot, one subframe, or one TTI. One TTI or one subframe may be constituted of one or a plurality of RBs. The RB may be referred to as a physical RB (PRB), a PRB pair, an RB pair, and the like.

The RB may include one or a plurality of resource elements (REs). For example, one RB may be a radio resource domain of one subcarrier or one symbol.

The above-described structures of the radio frame, subframe, slot, symbol, and the like are merely examples. For example, structures such as the number of subframes included in a radio frame, the number of slots included in a subframe, the number of symbols and RBs included in a slot, the number of subcarriers included in an RB, the number of symbols included in a TTI, a symbol length, and a cyclic prefix (CP) length are variously changeable.

The information, parameters, and the like described in this application may be represented in absolute values, relative values with respect to a certain value, or other information corresponding thereto. For example, the radio resources may be indicated by a certain index.

The information, signals, and the like described in this application may be represented by using any of various different techniques. For example, the data, instructions, commands, information, signals, bits, symbols, chips, and the like that are mentioned in the whole of the above description may be represented by voltages, currents, electromagnetic waves, magnetic fields or magnetic particles, optical fields or photons, and arbitrary combinations thereof.

The software, commands, information, and the like may be transmitted and received through a transmission medium. For example, when software is transmitted from a website, a server, or another remote source using wired technology (a coaxial cable, an optical fiber cable, a twist pair and a digital subcarrier line (DSL), and the like) and/or wireless technology (infrared rays, microwaves, and the like), the wired technology and/or the wireless technology are/is included in the definition of the transmission medium.

The radio base stations described in this application may be substituted with user terminals. For example, each aspect and embodiment of the present invention may be applied to a configuration in which communication established between the radio base station and the user terminal is substituted with communication between a plurality of user terminals (Device-to-Device: D2D). In this case, the user terminal 20 may have the functions the above-described radio base station 10 has. The terms “uplink” and “downlink” may be substituted with “side”. For example, an uplink channel may be substituted with a side channel.

In the same manner, the user terminal in this application may be substituted with a radio base station. In this case, the radio base station 10 may have the functions of the above-described user terminal 20.

The aspects or embodiments described in this application may be used alone, in combination, or by switching in accordance with execution. Notification about certain information (for example, notification about being X) is not limited to be explicit, but may be implicit (for example, without the notification about the information).

Notification about information is not limited to the aspects or embodiments described in this application, but may be performed in another way. For example, the notification about information may be performed by physical layer signaling (e.g., downlink control information (DCI) and uplink control information (UCI)), higher layer signaling (e.g., radio resource control (RRC) signaling, broadcast information (MIB (master information block), SIBs (system information blocks), and the like), and MAC (medium access control) signaling), other signals, and a combination thereof.

The RRC signaling may be referred to as an RRC message, and may be, for example, an RRC Connection Setup message, an RRC Connection Reconfiguration message, and the like. The MAC signaling may be notified by, for example, a MAC control element (MAC CE).

Each aspect or embodiment described in this application may be applied to systems using LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), CDMA2000, UMB (Ultra Mobile Broadband), IEEE 802.11 (Wi-Fi (trademark)), IEEE 802.16 (WiMAX (trademark)), IEEE 802.20, UWB (Ultra-WideBand), Bluetooth (trademark), and other appropriate systems, and/or next generation systems extended based thereon.

In the processing procedure, sequence, flowchart, and the like of each aspect or embodiment described in this application, steps may be performed in permuted order as long as there is no contradiction. For example, as to the method described in this application, the elements of various steps are proposed in exemplary order, and are not limited to the specific proposed order.

The present invention is described above in detail, but as a matter of course, it is apparent for those skilled in the art that the present invention is not limited to the embodiments described in this application. For example, the above embodiments may be used alone or in combination. The present invention can be modified and changed in other forms without departing from the intent and scope of the present invention defined by claims. Therefore, this application is intended to exemplarily describe the present invention, and has no limitation to the present invention.

This application is based on Japanese Patent Application No. 2016-038173 filed on Feb. 29, 2016. This application includes all of the contents.

1. A user terminal for performing communication using a transmission time interval (TTI) having a given TTI length, the user terminal comprising:
a measurement unit that performs measurement using a measurement resource dynamically assigned by a radio base station; and
a transmission unit that transmits an information related to a measurement result,
wherein the measurement unit performs measurement of a signal transmitted from another user terminal using the measurement resource.

2. The user terminal according to claim 1, wherein the measurement resource is designated by downlink control information included in a same TTI.

3. The user terminal according to claim 1, wherein the transmission unit transmits the information related to the measurement result in a different symbol of the TTI including the measurement resource.

4. The user terminal according to claim 1 any one of claims 1, wherein the transmission unit further transmits a reference signal using a dynamically assigned reference signal transmission resource.

5. The user terminal according to claim 4, wherein the reference signal transmission resource is designated by downlink control information included in a same TTI.

6. The user terminal according to claim 4, wherein the reference signal transmission resource and the measurement resource are assigned to different symbols of a same TTI.

7. The user terminal according to claim 4, wherein the transmission unit transmits the reference signal using the reference signal transmission resource, and transmits uplink data in a different symbol of the TTI including the reference signal transmission resource.

8. The user terminal according to claim 1, wherein the measurement resource is configured so as to correspond to a reference signal transmission resource for another user terminal, while a reference signal transmission resource is configured so as to correspond to a measurement resource for another user terminal.

9. A radio base station for establishing communication with a user terminal using a transmission time interval (TTI) having a given TTI length, the radio base station comprising:
a control unit that controls dynamic assignment of a measurement resource for the user terminal;
a transmission unit that transmits an information related to the measurement resource; and
a reception unit that receives a result of measurement by the user terminal on a signal of another user terminal using the measurement resource.

10. A radio communication method of a user terminal for performing communication using a transmission time interval (TTI) having a given TTI length, the radio communication method comprising:
performing measurement of a signal transmitted from another user terminal using a dynamically assigned reference signal transmission resource, using a measurement resource dynamically assigned by a radio base station; and
transmitting an information related to a measurement result.

11. The user terminal according to claim 2, wherein the transmission unit transmits the information related to the measurement result in a different symbol of the TTI including the measurement resource.

12. The user terminal according to claim 2, wherein the transmission unit further transmits a reference signal using a dynamically assigned reference signal transmission resource.

13. The user terminal according to claim 3, wherein the transmission unit further transmits a reference signal using a dynamically assigned reference signal transmission resource.

14. The user terminal according to claim 5, wherein the reference signal transmission resource and the measurement resource are assigned to different symbols of a same TTI.

15. The user terminal according to claim 5, wherein the transmission unit transmits the reference signal using the reference signal transmission resource, and transmits uplink data in a different symbol of the TTI including the reference signal transmission resource.

16. The user terminal according to claim 6, wherein the transmission unit transmits the reference signal using the reference signal transmission resource, and transmits uplink data in a different symbol of the TTI including the reference signal transmission resource.

17. The user terminal according to claim 2, wherein the measurement resource is configured so as to correspond to a reference signal transmission resource for another user terminal, while a reference signal transmission resource is configured so as to correspond to a measurement resource for another user terminal.

18. The user terminal according to claim 3, wherein the measurement resource is configured so as to correspond to a reference signal transmission resource for another user terminal, while a reference signal transmission resource is configured so as to correspond to a measurement resource for another user terminal.

19. The user terminal according to claim 4, wherein the measurement resource is configured so as to correspond to a reference signal transmission resource for another user terminal, while a reference signal transmission resource is configured so as to correspond to a measurement resource for another user terminal.

20. The user terminal according to claim 5, wherein the measurement resource is configured so as to correspond to a reference signal transmission resource for another user terminal, while a reference signal transmission resource is configured so as to correspond to a measurement resource for another user terminal.
